(19) United States
(12) Patent Application Publication
(10) Pub. No.: US 2020/0131019 A1
(43) Pub. Date: Apr. 30, 2020

(54) A PRODUCT IDENTIFIER AND A DELIVERY METHOD

(71) Applicant: Ray Bradley, Diggers Rest, Victoria (AU)

(72) Inventor: Ray Bradley, Diggers Rest, Victoria (AU)

(21) Appl. No.: 16/494,362

(22) PCT Filed: Mar. 14, 2018
(86) PCT No.: PCT/AU2018/050228

§ 371 Date: Sep. 16, 2019

(30) Foreign Application Priority Data
Mar. 14, 2017 (AU) 2017900884

(51) Int. Cl. B67D 7/34; B60P 3/22

(52) U.S. Cl. CPC B67D 7/344; B60P 3/2245

(57) ABSTRACT

A storage tank indicator for delivering petroleum products from a petroleum haulage tanker to storage tanks is disclosed. The indicator is co-operable with a product indicator associated with a product outlet on a petroleum haulage tanker to identify a storage tank for an indicated product. The indicator includes (a) a unit for displaying a storage tank identifier that is representative of an intended destination storage tank of a product and (b) an actuator that is operable to selectively display a storage tank identifier corresponding with the intended destination storage tank for the product. Associating the product outlet with a storage tank identifier assists with delivering the product into the intended destination storage tank. Also disclosed are a product destination indicator that incorporates the storage tank indicator and a method of delivering different petroleum products from a petroleum storage tanker to storage tanks at a service (gas) station.

### TECHNICAL FIELD

This invention relates to delivering petroleum products from a petroleum haulage tanker to storage tanks, for example at a retail service (gas) station, airports, farms and at military installations. While the invention will be described by reference to retail service stations, it will be appreciated that the invention is more broadly applicable.

### BACKGROUND ART

Retail service stations have a number of in-ground tanks and each is designated for storing a certain petroleum products. The inlets are usually located in a forecourt area of the service station to enable access by haulage trucks for delivering petroleum product. Accordingly, the inlets are recessed into the round are covered by cover plates as shown in FIG. 1. The cover plates are hinged to enable access to the inlet. Each inlet is marked by an identifier, such as a number, to distinguish between the different tanks and a disc that is colour coded according to a predetermined colour for the given petroleum product.

Petroleum haulage tankers typically carry 3 to 4 different petroleum products that are split between 6 to 8 compartments in the tanker. Therefore, when delivering petroleum products, the tanker driver must co-ordinate the delivery of the products from a number of outlets to a number of storage tanks and in the correct volumes. It is important that the correct product is delivered to the correct tank because some vehicles will only run on a specific type of petroleum product. For example, most mass production cars will tolerate a mixture of unleaded petrol, but their engines will not run on diesel. Some premium cars and sports cars will only run on at least 95 RON and sometimes only 98 RON. Diesel vehicles will only run on diesel. For this reason, the outlet for each compartment is associated with a product identifier, also known as a “tumbler” (see FIGS. 2 and 3). The product identifier has a cylinder on which the various petroleum products are identified and a window through which one of the product identification is visible. The cylinder can be rotated to display a selected petroleum product that is contained in the compartment that corresponds with that outlet.

When delivering petroleum products, the tanker driver has an instruction sheet which details how much of each petroleum product must be delivered to a given service station. The tanker driver inspects the storage tank identifiers to determine which tanks are designated for which products and notes the identifiers against the products on the instruction sheet because, while the numbering of the tanks from left to right may be the same at each service station, e.g. 1 to 4 or 1 to 6, the tank numbering and associated product for one service station changes for the next service station. In other words, one service station may have tank 1 designated for ethanol, tanks 2 and 3 designated for 91 RON unleaded (because it is sold in higher volumes that the other products), tank 4 designated for 95 RON unleaded, tank 5 designated for 98 RON and tank 6 designated for diesel. However, the next service station may have tank 1 designated for ethanol, tank 2 designated for diesel, tank 3 designated for 98 RON, tank 4 designated for 95 RON and tanks 5 and 6 designated for 91 RON. While tanker drivers are conscious of the changing designations between services stations, mixing of petroleum products in a storage tank still occurs because the tanker drivers must put down the instruction sheet to use two hands for coupling delivery hoses between the outlet on the tanker and the inlets of the storage tanks. As a result, tanker drivers sometimes confuse the tank number for a particular product with another tank number and, therefore, deliver the product into the wrong tank.

When the tank identifiers are determined, they are noted on the instruction sheet and a plan is drawn up for delivering product from compartments to tanks. However, the process involves putting down the instruction sheet each time delivery hoses are coupled and uncoupled.

Additionally, the instructions sheet is used scarcely when delivering product if it is raining because the instruction sheet is made of thin paper that can be tom easily if it gets wet. In this case, the notifications are made as described above, but the paper is placed inside the truck cabin, to ensure that is out of the rain, while the truck driver delivers the products from multiple outlets to multiple inlets on the basis of their memory.

Some service station chains have computerised systems that provide printouts of the identity of the tanks, their safe storage capacity and their available capacity. This information is passed to the tanker driver who must then allocate the products to the respective tanks based on their delivery docket which outlines the products and quantities carried by the haulage tanker. However, the same problems arise even with the computerised system printouts because the driver must still put down the printout and make a connection between the product indication on the tumbler and the tank identifier to ensure that the product is delivered to the correct tank.

Problems also arise when product is delivered at night-time because the coloured product designations at the inlets of the storage tanks are less visible. As shown in FIG. 1, it can be seen that the coloured identifiers are similar shapes and may not be lit well by street lighting or by lighting at the service station.

The industry term for mixed petroleum products in a storage tank is a “cross-over”. In the event of a cross-over, the storage tank must be emptied and cleaned and the product mixture must be disposed of in an environmentally friendly way. There is a very considerable cost for remediating a cross-over and that cost is borne by the haulage companies. The haulage companies cover the risk of cross-overs with insurance, but the cost of the insurance is included in the cost passed on by the haulage companies to the petroleum product suppliers for delivering the product.

It is also important for the tanker driver to correctly identify the destination storage tank for a product because the delivery instructions specify the delivery of a certain volume of product. If the tanker driver attempts to deliver a large volume of product to a tank that is designated for that product but which does not have capacity to receive the volume, then spillages occur. This is also termed a “cross-over”. This situation is very dangerous because the product will spill over forecourt areas of the service station where people usually are filling up their vehicles. There is a high risk of fire or explosion in this circumstance and, therefore, the service station is shut down immediately and vacated. Emergency services may be called into contain the risk while a clean-up is conducted. There is also environmental risk because the spilled petroleum product may make its way into storm water drains and, as a result, into river or sea ecosystems. As with mixing products in a given tank, there is a very considerable cost with cleaning up a spillage which is also borne by the haulage company. Again, the haulage companies have insurance to cover the scope of spillages.

There are clear economic incentives for the haulage company and the petroleum product supplier to reduce the occurrence of cross-overs and, therefore, reduce the insurance costs for delivering petroleum products. There are also clear environmental and safety incentives to reduce the occurrence of cross-overs.

The above references to the background art do not constitute an admission that the art forms a part of the common general knowledge of a person of ordinary skill in the art. The above references are also not intended to limit the application of the apparatus and method as disclosed herein.

The term “service station”, as used through the description and claims, is taken to mean a retailer of petroleum products, such as ethanol, unleaded petrol and diesel. It is also take to have the same meaning as the term “gas station”.

### SUMMARY OF THE DISCLOSURE

A key realisation of the applicant, and which realisation underpins the invention, is that associating a tank identifier (as opposed to a product identifier as currently is the case) at an outlet on the haulage tanker allows the truck driver to connect delivery hoses between corresponding tank identifiers. Furthermore, the tank identifiers can be set after the truck driver has inspected the tanks and noted the tank identifiers for the respective products to be delivered. This means that the instruction sheet can be used to set the tank identifiers at the outlet and can then be placed in the cabin of the truck because the truck driver no longer needs to refer to the instruction sheet once the tank identifiers are set at the outlets. The instruction sheet is, therefore, has minimum exposure to rain. Additionally, the truck driver can work more efficiently because he or she doesn't need to return to the cabin to inspect the instructions sheet for further details.

In one aspect, the invention provides a storage tank indicator that is co-operable with a product indicator associated with a product outlet on a petroleum haulage tanker to identify a storage tank for an indicated product, the storage tank indicator including:
(a) a unit for displaying a storage tank identifier that is representative of an intended destination storage tank of a product; and
(b) an actuator that is operable to selectively display a storage tank identifier

corresponding with the intended destination storage tank for the product, whereby associating the product outlet with a storage tank identifier assists with delivering the product into the intended destination storage tank.

According to one embodiment, the unit comprises a housing with a window and a barrel contained within the housing so that a portion of the barrel is visible through the window and the storage tank identifiers are located on the barrel to be visible through the window by operation of the actuator.

In another embodiment, the actuator has a catch that locks the barrel in a selected position and has a spring-loaded release that unlocks the barrel to enable selection of an alternative storage tank identifier.

In another embodiment, the actuator is configured to control the product indicator when the storage tank indicator is fitted to the product indicator.

In another embodiment, the storage tank indicator is configured to reset to a default position when the storage tank indicator is fitted to a product indicator and the actuator is operated to change a product indication on the product indicator.

In another aspect, there is provided a product destination indicator for a petroleum haulage tanker, the product destination indicator including:
(a) a storage tank indicator as described above; and
(b) a product indicator having a housing with a display window and a body rotatably mounted in the housing, the body having product descriptions arranged such that the product descriptions are visible through the window and the body is able to be positioned to display a selected product description.

The product indicator further includes, in one embodiment, a mounting plate projecting from the body for mounting the product indicator to a petroleum haulage tanker.

In another aspect, the invention provides a method of delivering different petroleum products from a petroleum storage tanker to storage tanks at a service station, each storage tank has a different storage tank identifier, the method includes:
(a) determining the storage tanks for the different petroleum products to be delivered;
(b) determining the storage tank identifiers that are associated with the determined storage tanks;
(c) displaying the storage tank identifiers at respective petroleum product outlets on the petroleum haulage tanker that correspond with the petroleum product designated for a storage tank; and
(d) connecting a product conveying hose between the matching storage tank identifiers at the product outlet and the storage tank.

In one embodiment, the method further includes determining the volume of the product to be delivered and delivering the determined volume.

### BRIEF DESCRIPTION OF THE DRAWINGS

Notwithstanding any other forms which may fall within the scope of the apparatus and method as set forth in the Summary, specific embodiments will now be described, by way of example only, with reference to the accompanying drawings in which:

FIG. 1 is a photograph of a typical array of storage tank identifiers at a service station.

FIG. 2 is a photograph of a petroleum product outlets on the side of a petroleum haulage tanker with a product indicator located above each outlet.

FIG. 3 is a front view of a product indicator located above the outlets in FIG. 2.

FIG. 4 is a rear view of a product indicator with a retro-fitted storage tank indicator according to one embodiment of the present invention.

FIG. 5 is an exploded isometric view of a product destination indicator according to one embodiment of the present invention.

FIG. 6 is a rear view of the product indicator shown in FIG. 4.

FIG. 7 is a product destination indicator that includes a product indicator and a storage tank indicator.

FIG. 8 is an exploded view of the product destination indicator in FIG. 7.

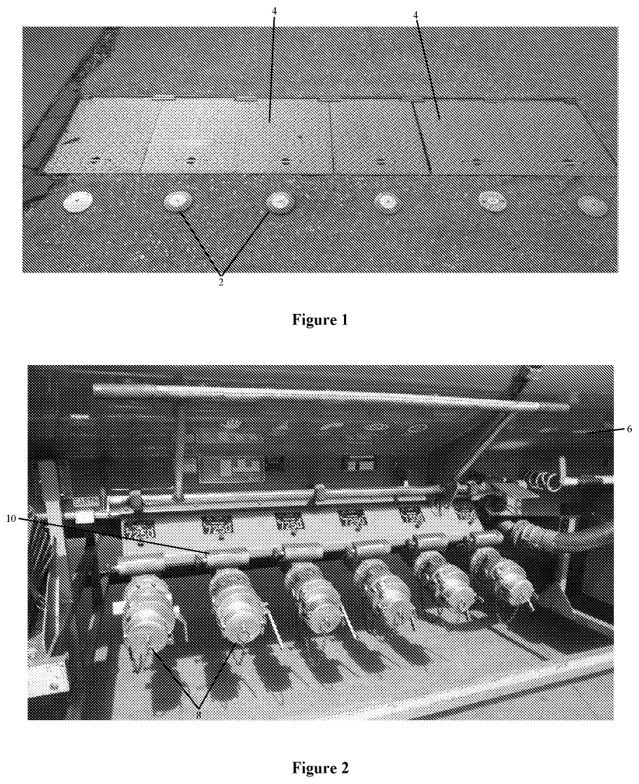

### DESCRIPTION OF EMBODIMENTS

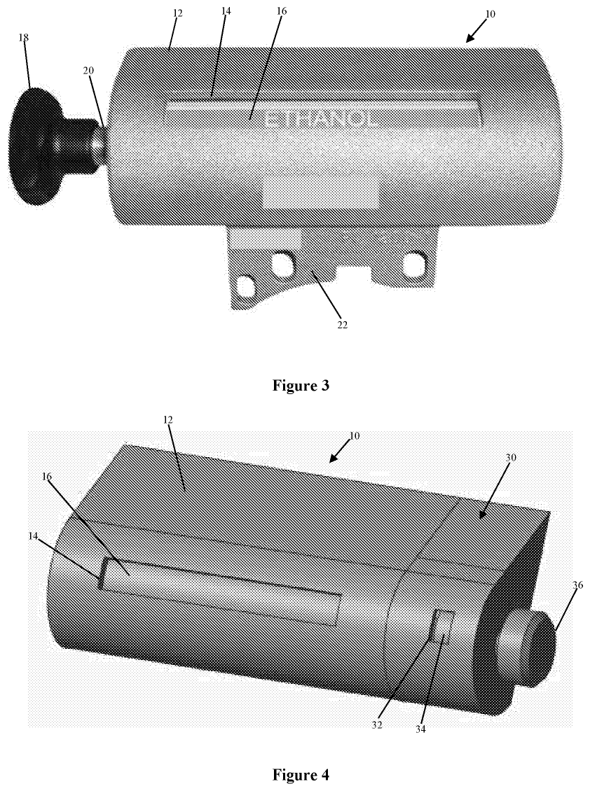

Embodiments of the invention are shown in FIGS. 4 to 7 and are described below in contrast to the product indicated 10 (otherwise known as a “tumbler”) in FIGS. 2 and 3.

Referring to FIG. 2, a series of outlets 8 are shown on the side of a petroleum haulage tanker (i.e. a petrol tanker). Set back from the end of each outlet 8 and on top of the outlet is a tumbler 10 in the form shown in FIG. 3. Specifically, the tumbler 10 includes a housing 12 with an elongate window 14 behind which is rotatably mounted a barrel 16 that is marked with a range of different petroleum products. The barrel is mounted on an axel 20 that is operable via a handle 18 to rotate the barrel 16 so that a desired petroleum product is displayed in the window 14. The desired petroleum product is selected by pushing the handle 18 so as to advance the axel 20 into the housing 12. This action disengages elements (not shown) inside the housing that mechanically locks the barrel in a designated position once the axel 20 and handle 18 are released. A compression spring located inside the housing is arranged to keep the elements interlocked so as to retain the barrel in a selected position. It is only by pushing the handle against the compression spring that the barrel can be released and rotated to display an alternative petroleum product.

The tumbler 10 further includes a mounting plate 22 that is suitably shaped to fit to or near an outlet 8 on the petrol tanker. This includes forming the mounting plate 22 with apertures through which fasteners, such as bolts, can be passed to secure the tumbler to the outlet.

One embodiment of the present invention is a storage tank indicator that can be retro-fitted to a tumbler. An example of such a storage tank indicator is shown in FIG. 4 and is denoted by reference numeral 30.

The storage tank indicator 30 comprises a housing 31 having a window 32 and a display wheel 34.

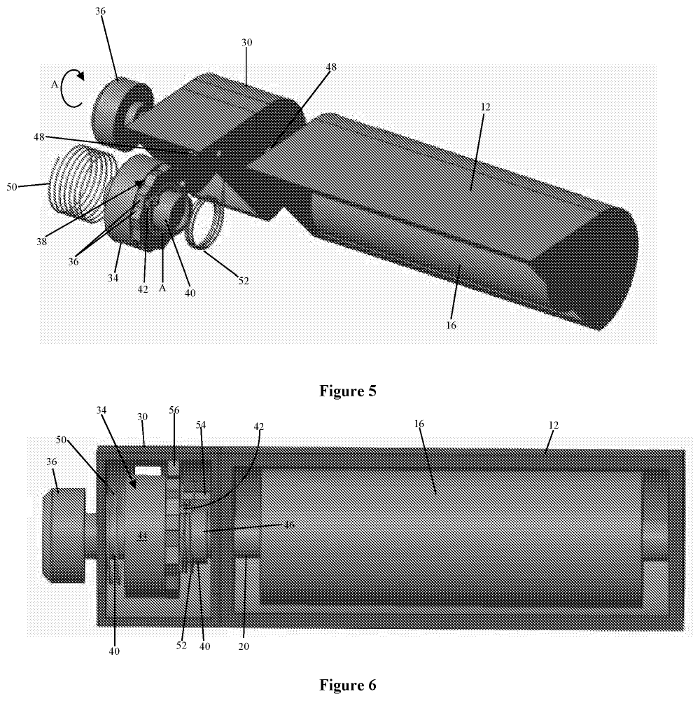

Having regard to FIGS. 5 and 6, the storage tank indicator comprises a unit for displaying a storage identifier. The unit is in the form of a housing 31 having a window 32, a wheel 34 for displaying storage tank indicators. The storage tank indicator 30 further comprises an actuator that can be operated to display a selected storage tank identifier. The actuator is in the form of a locking mechanism that fixes the wheel in a selected position and a re-setting mechanism that returns the wheel 34 to a default position.

The locking mechanism comprises a series of alternatively angled faces 36 on one side of the wheel 34. Two opposed faces 36 that are inclined toward each other define a indent 38 into which a stopper 56 that is fixed to an inside surface of the housing 31 so that when the stopper 56 is located in an indent 38, the wheel is prevented from rotating, thereby locking the wheel into position to display a selected storage tank identifier.

The wheel 34 includes an aperture there through which is extended by annular bosses 40 on either side of the wheel 34 to define a sleeve in which an end of the axel 20 is received. The sleeve has an internal diameter that is stepped so that a free end of the axel 20 abuts the shoulder of the step when the wheel is located in the position shown in FIG. 6. Pushing the handle 36 in the axial direction of the axel 20 toward the barrel 16 causes the end of the axel 20 to be pushed by the shoulder so that the axel 20 is advanced, thereby releasing the mechanical lock on the barrel 16 so that an alternative petroleum product can be selected by then rotating the handle 36 until the desired petroleum is displayed in the window 14. Releasing the handle 36 allows the mechanical lock to reengage and retain the barrel 16 in the desired position.

The actuator includes a compression spring 50 which is located about the boss 40 on the side of the wheel 34 that is adjacent to the handle 36. The compression spring abuts a sidewall of the housing 31 and a sidewall of the wheel 34 and therefore urges the wheel 34 away from the handle 36 so that the stopper 56 is retained in an indent 38, thereby locking the wheel 34 in position. However, pulling on the handle 36 causes the compression spring 50 to be compressed by side face of the wheel 34 closer to the sidewall of the housing 31. In doing so, the faces 36 are pulled out of alignment with the stopper 56 so that the wheel 34 can be freely rotated by rotating the handle 36 to select a desired storage tank identifier that is displayed on a surface 44 of the wheel 34. Once selected, the pulling force on the handle 36 released so that the compression spring 50 pushes the wheel longitudinally along the axel 20, thereby bringing the faces 36 back into alignment with the stopper 56 to lock the wheel in the desired position.

The actuator further includes a return spring 52, in the form of a torsion spring, that places a bias on the wheel 34 to return it to the default position. The default position will coincide with a position on the wheel that is blank, i.e. does not display any storage tank identifier. For example, if the storage tank identifiers comprise the numbers 1 to 6, then the default position involves returning the wheel 34 to displaying a colour, such as red, in the window 32, but no tank indicator. This avoids any carry-over of tank indicator from one job to the next because the tank indicator needs to be re-set each time a delivery is made.

One end of the return spring 52 is retained in a catch 42 on a side of the wheel 34 adjacent to the faces 36. The return coil 52 fits over the boss 34 adjacent to the barrel 16. The other end of the return spring 52 abuts a projection 54 that extends from a sidewall of the housing 31 rotating the handle 36 in the direction of the arrow marked A in FIG. 5 will cause the catch 42 to rotate in the same direction so that the return spring becomes loaded with a resistive force that acts against further turning of the handle 36 in the direction of the arrow marked A.

In one form, a printed strip bearing the default position and a series of tank identifiers is applied to the wheel 34. The tank indicators may be formed of a reflective medium, such as reflective tape or printed in reflective ink. Option that tank indicators are red on a white background. Further optionally, the printed strip has a sealing coat to ensure that the default position and the tank identifiers are legible in most conditions.

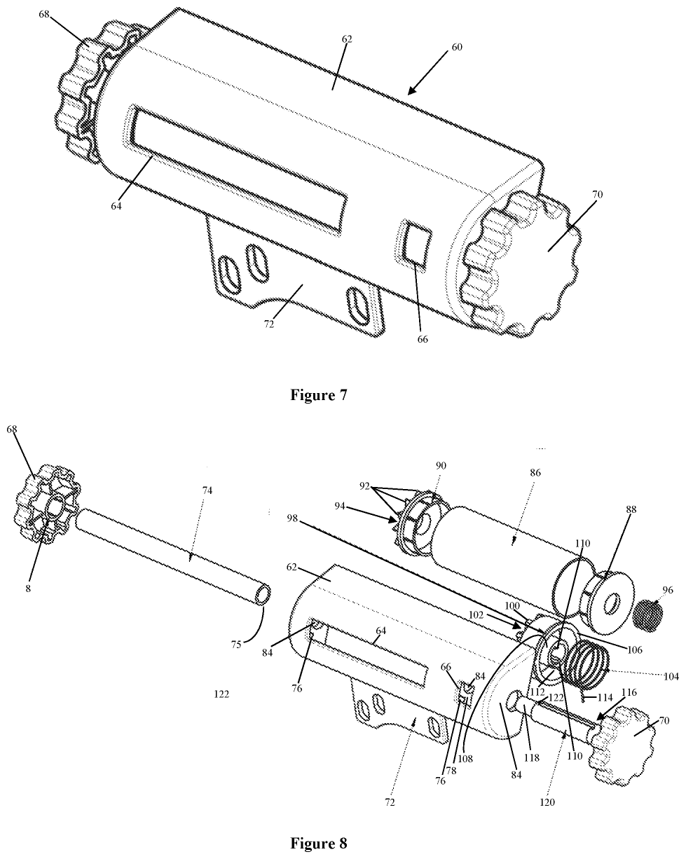

In another embodiment, a product destination indicator is provided in the form shown in FIGS. 7 and 8. Specifically, the product destination indicator incorporates a tank indicator with a tumbler.

As shown in FIG. 7, the destination indicator 60 includes a housing in the form of a body 62 having display windows in the form of product windows 64 and tank windows 66 and a body in the form of a cylinder 86 rotatably mounted within the body 62.

The body 62 is a hollow-open backed structure and has a partition 78 which segregates the volume defined within the body 62 into a product section 80 and a tank section 82. End walls of the body 62 and the partition have apertures 84 which are aligned.

The cylinder 86 is fitted with end caps 88, 90, each having an opening there through so that the cylinder can be threaded onto a shaft 74 which also passes through the partition and a sidewall corresponding with the product section 80 so as to rotatably mount the cylinder within the product section 80. A handle 68 is friction fit to a section of the shaft 74 which projects from the product section 80 outside the body 62. The end cap 90 includes radially extending teeth that stand proud of the end cap 88 in the direction of the longitudinal axis of the cylinder. The teeth 92 therefore define a series of recesses 94 adjacent the perimeter of the end cap 90. When the cylinder 86 is mounted in the body 62 a coil spring 96 is located between the end cap 88 and the partition 78 so as to place a spring bias on the cylinder 86 to urge the end cap 90 into engagement with a projection 76 on an end wall of the body 62. Provided that the projection 76 is located in one of the recesses 94, the cylinder 86 is mechanically locked in a position. The cylinder 86 is disengaged by pushing on the handle 68 to advance the shaft and therefore the cylinder toward the tank section 82, thereby compressing the coil spring 96 and moving the end cap 90 out of engagement with the projection 76. In this position, the handle can be freely rotated to select an alternative portion of the cylinder to be visible through the product window 64. The series of product descriptions are placed on the curved outer surface of the cylinder 86 so that rotating the handle 68 allows the user to select a desired product description to display in the product window 64.

On the other side of the partition 78 is a storage tank identifier display barrel 98, a return coil, stub shaft 116 and handle 70. The display barrel includes an outer sleeve 106 on the perimeter surface of which is marked the storage tank identifiers. An inner hub 108 is located concentrically relative to the sleeve 106 and is joined by a series of teeth that extend radially from the hub 108 to the sleeve 106. The teeth 100 define recesses 102 between them. When the display barrel 98 is located within the tank section 82 the return coil is located between the display barrel 98 and the end wall of the tank section and biases the display barrel 98 into contact with the partition 78. In doing so, one of the recesses 102 will receive the projection 76 so as to lock the display barrel in a selected position.

The display barrel 98, however, is mounted on the stub shaft 116 so that ribs 110 projecting radially inwardly of the hub 108 are received in grooves 120 on the stub shaft. When the stub shaft is threaded through the tank section from the side of the product section 80 end walls 122 will abut ends of the ribs so that, with the handle 70 mounted on the stub shaft 116, pulling of the handle 70 causes the end wall 122 to engage the ribs 110 and therefore displace the display barrel 98 axially of the stub shaft 116 in the same direction that the handle 70 is being pulled. This action releases the recess from the projection and allows the display 98 to be rotated freely to select an alternative tank identifier. As mentioned above, the resistance of the return coil 104 will provide a biasing force to urge the display barrel 98 in the direction of the product section so as to reengage one of the recesses 102 with the projection 76.

It will be appreciated that end 112 of the return coil (although not shown) is captured in a seat within a display barrel 98 and the other end 114 (which projects tangentially of the return coil 104 is captured by a projection or catch on the inside of the tank section (not shown). As a result, rotating the handle 70 to cause rotation of the display barrel 98 causes the return coil 104 to be torsionally loaded with a resistive force. Resistive force biases the display barrel 98 to return to a default position as described above in respect of the tank indicator 30.

The stub shaft 116 includes a reduced diameter portion 118 that is dimensioned to fit inside an end of the shaft 74. The diameter of the portion 118 is selected so that the stub shaft is able to rotate freely relative to the shaft 74 when the portion 18 is received within the end of the shaft 74.

The length of the shaft 74 and the stub shaft 116 are selected so that the end face 75 of the shaft 74 can abut a shoulder on the stub shaft which marks the transition between the portion 118 and the remainder of the stub shaft 116. This arrangement allows the display barrel to return to the default position 98 by adjusting the product on display in the product window 64. Specifically, pushing on the handle 68 will advance the shaft 74 in an axial direction towards the opposing handle 70. This will cause the end face 75 to abut the shoulder of the stub shaft 116 so that the stub shaft 116 gets pushed in the same direction. This pushing results in the walls 102 catching the ribs 110 on the display barrel and advancing the display barrel 98 in the same direction as the handle 68. The effect is that the end cap 90 and the display 98 are disengaged from the respective projections 76, thereby allowing them to rotate. The cylinder, however, must be rotated manually by turning the handle 68. The display barrel 98, in contrast, will be rotated to the default position by operation of the return coil 104 because the handle 70 and the stub shaft 116 are free to rotate relative to the shaft 74. Once the display barrel 98 is reset, the handle can be pulled to set an alternative storage tank identifier without interfering with the selection of the product which appears on display in the product window 64.

In each of the two embodiments described above, a storage tank identifier is selectable for display at the outlet of the petroleum product. This means that the truck driver is able to readily associate a specific outlet with a destination storage tank. In other words, the truck driver need only connect delivery hoses between outlets on the petrol tanker with an inlet on the storage tank by reference to the same storage tank identifier.

As a result of locating the storage tank identifier at the outlet on the petrol tanker, the method of delivering petroleum products, according to one embodiment, is as follows.

The truck driver first determines the storage tanks to which the different petroleum products are to be delivered. The truck driver then determines the storage tank identifiers that are associated with the determined storage tanks. This may be done by noting down on an instruction sheet the storage tank identifiers next to the products to be delivered according to the instruction sheet. For example, this may mean identifying storage tank 1 which is designated for diesel, on the instruction sheet where the diesel delivery details are set out. The same is done for other storage tank identifiers for other products that are to be delivered. Those storage tank identifiers are then displayed at the outlet that corresponds to the petroleum product that is to be delivered. Going back to the example above, this means that the truck driver would find the diesel outlet on the petrol tanker and adjusts the tank indicator 30 or the destination indicator 60 to display tank number 1 next to the product description of “diesel”. The same process is taken in respect of other petroleum products to be delivered.

The next step involves the truck driver connecting the delivery hoses between outlets on the petrol tanker and inlets on the storage tanks which have matching storage tank identifiers.

It is anticipated that this method reduces the risk associated with truck drivers attempting to connect delivery hoses between displayed products at the outlets on the tanker and storage tank identifiers at the inlets on the storage tanks. Therefore, it is anticipated that there will be reduced incidents of cross-overs.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1. A storage tank indicator that is co-operable with a product indicator associated with a product outlet on a petroleum haulage tanker to identify a storage tank for an indicated product, the storage tank indicator including:
(a) a unit for displaying a storage tank identifier that is representative of an intended destination storage tank of a product; and
(b) an actuator that is operable to selectively display a storage tank identifier corresponding with the intended destination storage tank for the product,
whereby associating the product outlet with a storage tank identifier assists with delivering the product into the intended destination storage tank.

2. The storage tank indicator of claim 1, wherein the unit comprises a housing with a window and a barrel contained within the housing so that a portion of the barrel is visible through the window and the storage tank identifiers are located on the barrel to be visible through the window by operation of the actuator.

3. The storage tank indicator of claim 1, wherein the actuator has a catch that locks the barrel in a selected position and has a spring-loaded release that unlocks the barrel to enable selection of an alternative storage tank identifier.

4. The storage tank indicator of claim 1, wherein the actuator is configured to control the product indicator when the storage tank indicator is fitted to the product indicator.

5. The storage tank indicator of claim 1, wherein the storage tank indicator is configured to reset to a default position when the storage tank indicator is fitted to a product indicator and the actuator is operated to change a product indication on the product indicator.

6. A product destination indicator for a petroleum haulage tanker, the product destination indicator including:
(a) a storage tank indicator according to claim 1; and
(b) a product indicator having a housing with a display window and a body rotatably mounted in the housing, the body having product descriptions arranged such that the product descriptions are visible through the window and the body is able to be positioned to display a selected product description.

7. The product indicator of claim 6 further including a mounting plate projecting from the body for mounting the product indicator to a petroleum haulage tanker.

8. A method of delivering different petroleum products from a petroleum storage tanker to storage tanks at a service station, each storage tank has a different storage tank identifier, the method includes:
(a) determining the storage tanks for the different petroleum products to be delivered;
(b) determining the storage tank identifiers that are associated with the determined storage tanks;
(c) displaying the storage tank identifiers at respective petroleum product outlets on the petroleum haulage tanker that correspond with the petroleum product designated for a storage tank; and
(d) connecting a product conveying hose between the matching storage tank identifiers at the product outlet and the storage tank.

9. The method of claim 8, wherein the method further includes determining the volume of the product to be delivered and delivering the determined volume.
